(19) United States
(12) Patent Application Publication
(10) Pub. No.: US 2015/0059801 A1
(43) Pub. Date: Mar. 5, 2015

(54) PET HAIR COLLECTOR

(71) Applicant: Swipets, LLC, Old Chatham, NY (US)

(72) Inventor: Donna Meté, Old Chatham, NY (US)

(73) Assignee: Swipets, LLC, Old Chatham, NY (US)

(21) Appl. No.: 14/534,077

(22) Filed: Nov. 5, 2014

Related U.S. Application Data
(63) Continuation-in-part of application No. 14/015,427, filed on Aug. 30, 2013.
(60) Provisional application No. 61/837,900, filed on Jun. 21, 2013.

(51) Int. Cl. B08B 6/00

(52) U.S. Cl. CPC B08B 6/00
USPC 134/1

(57) ABSTRACT

The present invention relates to pet hair collectors. In some embodiments, the present disclosure relates to a material having a surface which, due to its specific manufacturing and curing process, provides a tacky surface and additionally develops an electrostatic charge during use that further serves to attract pet hair. The material preferably maintains all or most of its efficacy after repeated washing. The material is particularly adapted to removing pet hair when the material is placed in contact with (e.g., brushed against) the pet hair. In some embodiments, an existing glove made of a material such as nylon and/or elastane (Spandex), or bamboo, is coated with a material such as nitrile rubber which is partially cured to obtain the desired tack and electrostatic charging properties. In other embodiments, the pet hair collector includes a removable covering for a cleaning instrument.

### REFERENCE TO RELATED APPLICATION

The current application is a continuation-in-part application of U.S. patent application Ser. No. 14/015,427, which was filed on 30 Aug. 2013, which claims the benefit of co-pending U.S. Provisional Application No. 61/837,900, titled “Pet Glove,” which was filed on 21 Jun. 2013, both of which are hereby incorporated by reference.

### BACKGROUND

1. Technical Field

The present invention relates to pet hair collectors for removing pet hair from, for example, all fabrics, and objects with fabric, clothing, pillows, comforters, furniture, etc.

2. Background of the Invention

Pets, such as dogs and cats, accumulate and shed a significant amount of hair. Various vacuums and other apparatuses have been developed to address pet hair accumulation in the caretaker's house. However, such machines are often expensive and not fully efficacious in removing pet hair.

U.S. Pat. No. 6,024,970 (“the '970 patent”) describes a disposable lint mitt that includes an adhesive. There is no mention in the '970 patent that the mitt would be efficacious in removing pet hair. Moreover, because the mitt of the '970 patent includes an adhesive, it can only be used one time before it must be discarded.

U.S. Pat. No. 6,460,191 (“the '191 patent”) describes a disposable, paw-shaped pet hair removal glove that includes a strong adhesive on the palm side. Because the glove of the '191 patent uses an adhesive, like the mitt of the '970 patent, it can be used only one time and must include a protective film covering to protect the adhesive before use.

U.S. Design Pat. No. 466,662 (“the '662 patent”) is by the same inventor as the '191 patent and was filed on the same day. There is no discussion in the '662 patent on the composition of the glove disclosed therein.

Finally, Petco Animal Supplies, Inc. (San Diego, Calif.) sells the Evercare Pet Hair Pic-Up Mitt. According to user reviews of the product, the mitt is not efficacious in removing some types of pet hair (such as short hair) and is not efficacious removing pet hair from some objects. In addition, the mitt is not form-fitting.

Various non-glove products exist for removing pet hair. For example, two products are marketed through infomercials as the SCHTICKY and STICKY BUDDY. Each product is advertised as including a reusable lint roller and claims to be effective at removing lint and pet hair. The roller for the SCHTICKY is advertised as being silicone-based, while the roller for the STICKY BUDDY is described as being made out of silicone rubber. Both rollers are advertised as being washable. However, roller-based products are not suitable and/or desirable for many applications, can be used only on flat surfaces and cannot remove pet hair from corners, cracks and crevices.

Thus, there remains a continuing need for apparatuses to pick-up pet hair.

### BRIEF SUMMARY

The present disclosure relates to apparatuses configured to collect pet hair.

In some embodiments, the present disclosure provides a wearable hand covering, such as a glove, for removing pet hair. In some embodiments, the glove is a form-fitting glove with elastic properties so that the glove can stretch or contract based on the size of the human user's hand and fingers, thereby providing increased dexterity and/or control for the user over prior art products. In some embodiments, at least a portion of the glove, such as a palm portion of the glove, is sticky to the touch (e.g., tacky). Additionally, the glove works, at least in part, via an electrostatic charging attraction between the glove and the pet hair. In some embodiments, the glove is a coated glove that includes a plurality of fingers configured to receive fingers of a human, a palm portion configured to cover the human's palm when the human's fingers are inserted into the plurality of fingers, a back hand portion configured to cover the back of the human's hand when the human's fingers are inserted into the plurality of fingers and a glove opening defined by the back hand portion and the palm portion at a side opposite to the plurality of fingers so that the human's hand can be inserted through the glove opening. In some embodiments, the glove is comprised of a fabric. In some embodiments, the fabric is a fiber such as nylon, spandex (elastane) and/or bamboo.

In some embodiments, the glove further includes a coating comprising a nitrile and/or a silicone bound to the fabric or other material making up the glove. In some embodiments, the nitrile is poly(butadiene-co-acrylonitrile). In some embodiments, the nitrile has a Mooney viscosity of between about 30 and about 50 MU when determined according to ISO 289. In some embodiments, the coating further includes an emulsifier/wetting agent, such as octylphenol ethoxylate, sodium dihexylsulphosuccinate or sodium 4-(5-dodecyl)benzenesolfonate, an antioxidant, such as N,N′-di-sec-butyl-p-phenylenediamine, a filler, such as clay or titanium oxide and/or solvent(s) such as water, ethanol or 2-butanone. In some embodiments, the nitrile is adhered to the first material via an adhesive. In some embodiments, the nitrile is induced to bond to the supporting fabric glove by use of a coagulant such as calcium nitrate that can be supplemented with calcium carbonate. In some embodiments, the coating substantially covers at least the palm portion of the first material. In some embodiments, the coating substantially covers only the palm portion of the first material.

In some embodiments, the glove may or may not include fingers. In such embodiments, the glove may be a coated glove that includes a glove comprising a plurality of finger openings configured to allow a human's fingers to pass there through; a palm portion adjacent to the plurality of finger openings and configured to cover a human's palm when the human's fingers are inserted through the finger openings; a back hand portion configured to cover the back of the human's hand when the human's fingers are inserted through the finger openings; and a glove opening defined by the back hand portion and the palm portion at a side opposite to the finger openings so that the human's hand can be inserted through the glove opening, the glove comprised of a first material. Preferably, the glove includes a coating bound to the first material.

The present disclosure also provides a method of using a wearable hand covering, such as a glove, to remove pet hair. In some embodiments, the method includes a) providing the coated glove; and b) removing the pet hair with the coated glove. In some embodiments, the method can further include washing the coated glove and reusing the coated glove to remove pet hair.

The present disclosure also provides a method of making a wearable hand covering, such as a glove, configured to remove pet hair. In some embodiments, the method includes a) providing a glove that includes a plurality fingers configured to receive fingers of a human, a palm portion configured to cover the human's palm when the human's fingers are inserted into the plurality of fingers; a back hand portion configured to cover the back of the human's hand when the human's fingers are inserted into the plurality of fingers; a glove opening defined by the back hand portion and the palm portion at a side opposite to the plurality of fingers so that the human's hand can be inserted through the glove opening, the glove comprised of a first material; b) applying (e.g., by dipping the glove in) a coating composition comprising a nitrile and c) partially curing (vulcanizing) the coating so as not to cross-link the nitrile 100%. Optionally, an adhesive or coagulant is added before step b). In some embodiments, the method further includes applying a thinner to the glove and/or the coating composition prior to step b) and/or applying an adhesive to the glove and/or the coating composition prior to step b). In some embodiments, the adhesive is poly(vinyl alcohol) and/or poly(vinyl acetate).

In other embodiments, the pet hair collector is configured as another type of removable covering (e.g., for a handled surface cleaning instrument, such as a mop, a duster, and/or the like), as a contact surface for another type of cleaning instrument, such as a roller, and/or the like, that includes a nitrile coating.

In some embodiments, the present disclosure provides a removable covering for removing pet hair. In some embodiments, the removable covering is sized and has elastic properties so that the removable covering can stretch or contract based on a surface of a cleaning instrument over which the removable covering can be placed. In some embodiments, at least a portion of the removable covering is sticky to the touch (e.g., tacky) and attracts pet hair via an electrostatic charging attraction between the removable covering and the pet hair. In some embodiments, the removable covering is comprised of a fabric. In some embodiments, the fabric is a fiber such as nylon, spandex (elastane) and/or bamboo. In some embodiments, the removable covering includes a coating described herein bound to the fabric or other material making up the removable covering. In some embodiments, the coating comprises a partially cured nitrile.

The present disclosure also provides a method of using a removable covering to remove pet hair. In some embodiments, the method includes placing the removable covering over a surface of a cleaning instrument; and removing the pet hair with the cleaning instrument. In some embodiments, the method can further include washing the removable covering and reusing the removable covering to remove pet hair.

The present disclosure also provides a method of making a removable covering configured to remove pet hair. In some embodiments, the method includes providing a material, such as an elastic fabric, and applying a coating composition described herein to at least a portion of the material. In some embodiments, the coating composition comprises a nitrile, which is subsequently partially cured so as not to cross-link the nitrile 100%. In some embodiments, the method further includes applying a thinner and an adhesive to the material and/or the coating composition prior to applying the coating composition to the material.

### BRIEF DESCRIPTION OF THE DRAWINGS

FIG. 1a illustrates a side, elevation view of a glove of one embodiment of the present invention.

FIG. 1b illustrates a side, elevation view of a fingerless glove of one embodiment of the present invention.

FIG. 1c illustrates a top, isometric view of a glove of one embodiment of the present invention.

FIG. 2 illustrates a side, close-up, elevation view of a glove of one embodiment of the present invention.

FIG. 3 illustrates an isometric view of a glove of one embodiment of the present invention.

FIG. 4 is a FT-IR/ATR spectrum of the back hand portion of a glove of one embodiment of the present invention.

FIG. 5 is a FT-IR/ATR spectrum of the palm portion of a glove of one embodiment of the present invention.

FIG. 6 is a GC-MS total ion chromatogram of a glove of one embodiment of the present invention extracted with chloroform.

FIG. 7 is a GC-MS total ion chromatogram of a glove of one embodiment of the present invention extracted with benzene.

FIG. 8 is a GC-MS total ion chromatogram of a glove of one embodiment of the present invention extracted with DMF (N,N-dimethylformamide).

FIG. 9 is a GC-MS total ion chromatogram of a glove of one embodiment of the present invention extracted with tetrahydrofuran.

FIG. 10 is a HPLC chromatogram of a glove of one embodiment of the present invention and a procedural blank.

FIG. 11 is a total ion chromatogram of a glove of one embodiment of the present invention and a procedural blank using the positive APCI mode.

FIG. 12 is a total ion chromatogram of a glove of one embodiment of the present invention and a procedural blank using the negative APCI mode.

FIG. 13 is a mass spectra of Compound 1 found in a glove of one embodiment of the present invention.

FIG. 14 is a mass spectra of Compound 2 found in a glove of one embodiment of the present invention.

FIG. 15 is a mass spectra of Compound 3 found in a glove of one embodiment of the present invention.

FIG. 16 illustrates an isometric view of a coated roller of one embodiment of the present invention.

FIG. 17 illustrates a close-up, isometric view of the roller of FIG. 16.

FIGS. 18A-18C show top, isometric, and close up views of a removable covering of one embodiment of the present invention.

### DETAILED DESCRIPTION

The present disclosure relates to apparatuses for removing pet hair from surfaces. In some embodiments, the present disclosure relates to a substrate, such as a roller or glove, that is coated with a chemical that attracts pet hair and is reusable and washable. In some embodiments, the present disclosure relates to a removable covering, such as a removable cleaning pad, that is coated with a chemical that attracts pet hair and is reusable and washable.

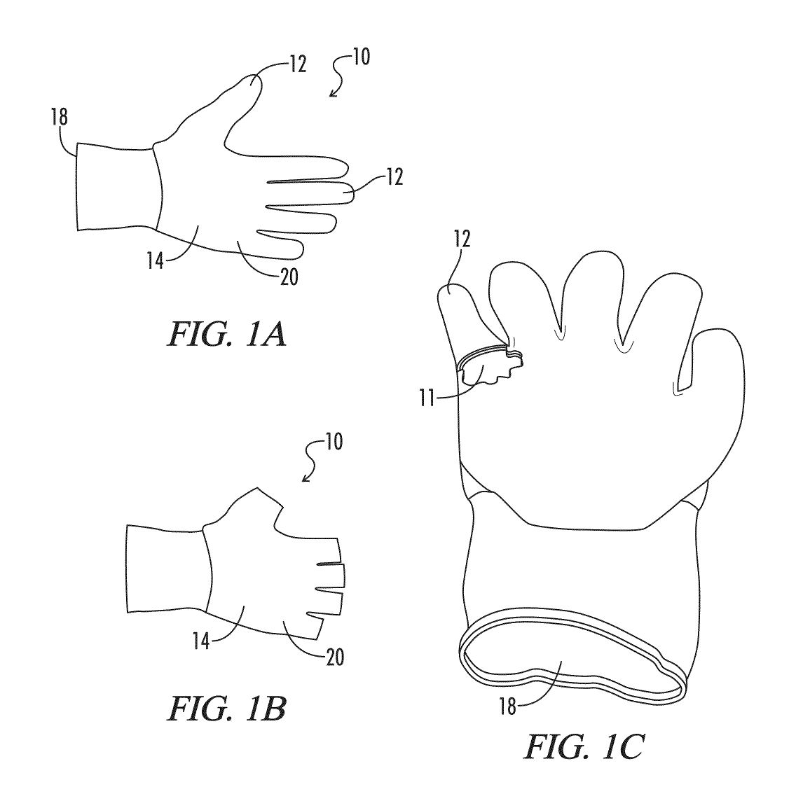

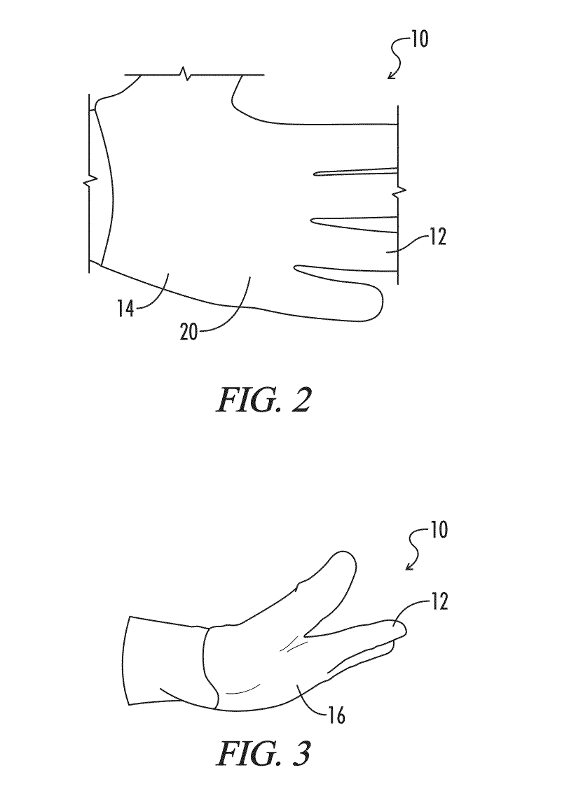

Referring to FIGS. 1-3, in some embodiments, the present disclosure provides a wearable hand covering, such as a glove, for removing pet hair, which is designated by the numeral 10. In the drawings, not all reference numbers are included in each drawing for the sake of clarity.

In some embodiments, the glove 10 is a coated glove that includes a plurality of finger openings 11 that may lead to a plurality of fingers 12 configured to receive fingers of a human, a palm portion 14 configured to cover the human's palm when the human's fingers are inserted through the plurality of finger openings 11 and optionally into the plurality of fingers 12, a back hand portion 16 configured to cover the back of the human's hand when the human's fingers are inserted through the finger openings 11 and optionally into the plurality of fingers 12 and a glove opening 18 defined by the back hand portion 16 and the palm portion 14 at a side opposite to the plurality of finger openings 11 so that the human's hand can be inserted through the glove opening 18. In some embodiments, the glove 10 includes five fingers 12 as shown in the illustrations in order to accommodate the thumb and four fingers of a human's hand. In other embodiments, the glove 10 may be a mitt that includes a first finger 12 for the human's thumb and a second finger 12 for the four other fingers of a human's hand. In still other embodiments, the glove 10 may be a fingerless glove that lacks fingers 12. Preferably, however, the glove 10 includes a plurality of fingers 12. It is further preferred that the glove 10 is form-fitting and elastic so that the glove can accommodate users having various sized fingers and hands. The glove 10 also can provide increased dexterity and/or control for the user (e.g., the user can grab, and get into areas (cracks, crevices, etc.) whereas other prior art products do not enable such uses.

The glove 10 is comprised of a first material, which may be, for example, a fabric comprised of a plurality of fibers such as a polyamide. In some embodiments, the polyamide is nylon. In addition to, or instead of nylon, the first material may be comprised of spandex (elastane) or bamboo.

In some embodiments, at least a portion of the glove 10, such as a palm portion 14 of the glove 10, is sticky to the touch (e.g., tacky). In some embodiments, the coated glove 10 further includes a coating 20 bound to the first material. In some embodiments the coating is a nitrile and/or a silicone. As known to those of ordinary skill, a nitrile is a chemical compound with carbon triple bonded to nitrogen. Preferably, the nitrile is a nitrile polymer. In some embodiments, the nitrile is poly(butadiene-co-acrylonitrile), alone or in combination with other nitriles. In some embodiments, the coating 20 further includes an emulsifier such as octylphenol ethoxylate, a wetting agent, an antioxidant, a filler or solvent. In some embodiments, the nitrile is adhered to the first material of the glove 10 via an adhesive, such as dodecyl acrylate or another acrylic adhesive such as poly(vinyl)acrylate. Preferably, if included, the adhesive is covered by the coating so that the glove is not too tacky. In some embodiments, the coating 20 substantially covers at least the palm portion 14 of the glove 10. Preferably, prior to use, the coating is dried—i.e., not wet.

Nitrile synthetic tri-polymers display similar characteristics to rubber once they have been vulcanized (a process where the latex film is heated, and the curing or vulcanizing mixture, typically a combination of sulfur, accelerator and heat cause cross-linking of the rubber, giving strength and elasticity to the film). Nitrile also has no natural rubber proteins and therefore eliminates the well-documented protein risks associated with natural rubber latex. Nitrile conforms to the shape of wearer's hands, has good puncture resistance, greater chemical protection and, because it contains no latex proteins, Type 1 Latex Allergy is eliminated. Preferably, the glove 10 is hypoallergenic.

The present disclosure also provides a method of using a substrate described herein, such as the glove 10, to remove pet hair. In some embodiments, the method includes a) providing the glove 10; and b) removing the pet hair with the glove 10. In some embodiments, the pet hair is removed by putting the object (e.g., the human's clothes, fabrics, pillows, comforters or furniture) in contact with the glove 10, preferably with the portion of the glove 10 that includes the coating 20 (e.g., with the palm portion 14). In some embodiments, the object is brushed or swiped with the glove 10. In some embodiments, the method can further include washing the glove 10 (e.g., with water) and reusing the glove 10 to remove pet hair.

The present disclosure also provides a method of making a substrate described herein, such as the glove 10. In some embodiments, at least a portion of the glove 10, such as the palm portion 14 of the glove 10, is sticky to the touch (e.g., tacky). In some embodiments, the method includes a) providing a glove 10 that includes a plurality of finger openings 11 that optionally lead to a plurality of fingers 12 configured to receive fingers of a human, a palm portion 14 configured to cover the human's palm when the human's fingers are inserted into the plurality of finger openings 11, a back hand portion 16 configured to cover the back of the human's hand when the human's fingers are inserted into the plurality of finger openings 11, a glove opening 18 defined by the back hand portion 16 and the palm portion 14 at a side opposite to the plurality of openings 11 so that the human's hand can be inserted through the glove opening 18, and the glove 10 is comprised of a first material; b) applying (e.g., by dipping the glove 10 in) a coating composition comprising a silicone and/or a nitrile to provide a coated glove 10; and c) partially but not completely curing the coated glove 10 by, for example, heating the glove 10 or leaving the glove 10 at room temperature so that the coating is partially cross-linked. In some embodiments, the glove 10 is a fingerless glove that lacks fingers 12, as described herein. In some embodiments, the method further includes applying a thinner to the glove 10 and/or the coating composition prior to step b) and/or applying an adhesive to the glove 10 and/or the coating composition prior to step b). Without being bound by any particular theory, it has been observed that if the glove 10 is completely cured (dried), the glove 10 loses its effectiveness (e.g., tackiness). It has also been observed that if the glove 10 is not sufficiently cured, the glove 10 is too tacky and breaks apart. Thinners that may be used in conjunction with the present invention include, for example, water, alcohols such as ethanol, isopropanol, and 1-methoxy-2-propanol, tetrahydrofuran, 1,4-dioxane and propylene glycol monomethyl ether. Optionally, the method further includes adding a tackifier (e.g., rosin) to at least one of the glove and the coating composition prior to step b).

Partially curing the glove 10 may be accomplished by, for example, reducing the temperature of curing, the time of the curing process, the composition of the curing agent, the amount of the curing agent, or by chemically neutralizing the curing agent before full cure is achieved. In some embodiments, the glove 10 is cured at between about 0 and about 75% of the recommended curing temperature of the nitrile or silicone coating 20. In another embodiment, the glove is cured between about 25% and 50% of the recommended curing temperature of the nitrile or silicone coating 20. In another embodiment, the glove 10 is cured between about 50% and about 75% of the recommended curing temperature of the nitrile or silicone coating 20. Optionally, the coating has a thickness of between about 50 and about 250 microns. The thickness of five total locations on gloves prepared using a method described herein was measured and it was determined that the coating had a thickness of between about 78 and about 198 microns.

Preferably, the glove 10 is not washed after step c). As known to those of ordinary skill, nitrile gloves in the prior art are typically washed after curing to remove impurities. In the instant application, however, where an initially tacky, nitrile glove 10 is desired, it is advantageous to keep the impurities, which may add to the initial tackiness and/or electrostatic properties of the glove 10. While the glove 10 is described as having an initial tackiness, the inventor has found that the glove 10 remains effective at removing pet hair from a plethora of surfaces even after the tackiness is reduced after one or many uses of the glove 10. In an embodiment, a surface of the glove can be rough and non-uniform (e.g., vary by approximately 100 to approximately 200 microns), which can assist with entanglement by grabbing hairs and dragging them around.

In some embodiments, the coating composition 20 is supplemented with one or more components found in the SCHTICKY roller (Square One Entertainment, Inc., Miami Beach, Fla.).

Without being bound by any particular theory, it is believed that the coated glove 10 collects pet hair by being slightly tacky and also due to electrostatic charging between the glove 10 and pet hair. Electrostatic charging refers to the phenomena observed when two materials with neutrally charged surfaces come into contact (<4 angstroms) and then separate, the materials undergo tribocharging and acquire a non-neutral surface charge level. The level and polarity of this newly acquired surface charge is dependent on several factors, but can be relatively answered by considering the triboelectric series. A material such as glass that comes into contact with a vinyl material will acquire a more positive charge because it is near the more positive position in the triboelectric series relative to the position of vinyl. Alternately, the vinyl will acquire a more negative charge following the same logic. The fact that these two materials are far apart from each other in the series may result in a larger charge level generated than if the glass came into contact with, for example, aluminum.

In the case of the present invention, without being bound by any particular theory, it is believed that when the glove 10 contacts pet hair, the pet hair becomes more positively charged and the nitrile or silicone becomes more negatively charged. Optionally, the nitrile or silicone can be modified to contain carboxyl groups. In some embodiments the nitrile or silicone contains about 1-10% carboxyl groups. In an embodiment, a nitrile contains 7% carboxyl groups. It has been observed that when pet hair is collected by the coated gloves 10, the pet hair tends to stick to itself (coadhere/ball up) on the glove 10. Without being bound by any particular theory, it is believed that friction between the pet hair and the nitrile causes electrons (negatively charges particles) to move from the pet hair to the nitrile. This leaves the nitrile with excess electrons and thus a negative charge and the pet hair with a deficit and a positive charge. Since opposite charges attract, the pet hair clings to the nitrile. In addition, because similar charges repel, once charged there will be a repulsive force between individual pet hairs. However, in the glove 10, the pet hairs roll up and become entangled/ball up, which overwhelms the repulsive force between the individual pet hairs and causes the individual hairs to stick together. Preferably, the coated glove 10 is configured to adhere to pet hair. For purposes of the present invention, the term “adhere to pet hair” when used in conjunction with the coated glove 10 means that the coated glove 10 adheres to most if not all cat hair and at least some types of dog hair, especially long-haired dogs, it being understood that the coated glove 10 need not adhere to all types of dog or cat hair. For example, to date, it has been observed that the coated glove 10 of Examples 1 and 2 adheres to all cat hair but is not particularly efficacious in adhering to the short, wiry hair of some dogs.

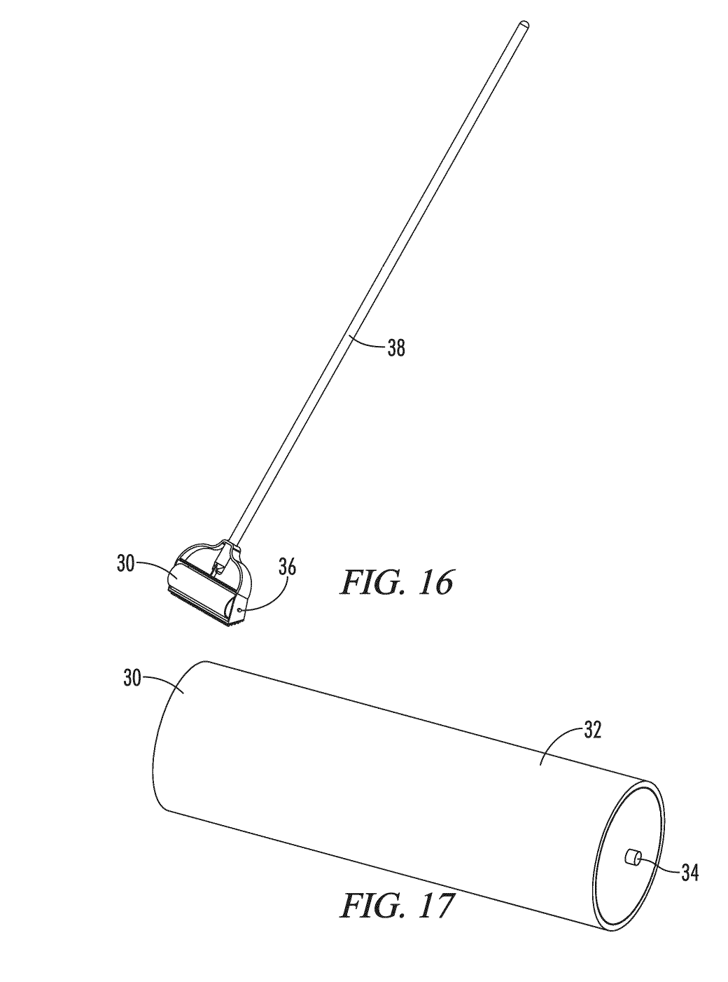

Referring to FIGS. 16-17, in other embodiments, the pet hair collector is a roller 30 that includes a nitrile-based coating 32 and, optionally, further includes a pivot pin 34, a bracket 36 that is attached to the pivot pin 34 and that is configured to allow the roller 30 to rotate about the pivot pin 34, and a handle 38 attached to the bracket 36. Preferably, the nitrile coating is partially cured and attracts pet hair via the roller's tackiness as well as an electrostatic adhesion between the pet hair and the nitrile coating. In addition to the nitrile coating, the roller may include one or more features described in, for example, U.S. Pat. No. 8,490,236, the contents of which are incorporated by reference in their entirety. Optionally, the roller is cylindrical. Optionally, the handle 38 is a pole.

In still other embodiments, the pet hair collector is a removable covering for various types of cleaning instruments. For example, the pet hair collector can comprise a substrate described herein with an elastic opening for selectively covering and uncovering a surface of a cleaning instrument. Alternatively, the pet hair collector can be a substantially rectangular material that can be held by a user and/or applied to a surface of a cleaning instrument using any solution during use. For example, the cleaning instrument can include one or more features described in U.S. Pat. No. 6,305,046, the contents of which are incorporated by reference in their entirety. Still further, the pet hair collector can comprise a surface of a handled cleaning instrument, which can allow for more ready cleaning of various surfaces, such as flooring (e.g., below furniture), and/or the like.

In other embodiments, the pet hair collector includes a cleaning instrument with one or more removable coverings. For example the cleaning instrument can include a handle 38, a cleaning surface (e.g., the roller 30, a mop head, and/or the like), and a pivotal and/or rotatable attachment mechanism (e.g., a pivot pin 34 and a bracket 36, a universal joint, and/or the like) attaching the handle 38 to the cleaning surface. The cleaning instrument can further include one or more removable coverings described herein for use in conjunction with the cleaning instrument. In some embodiments, the removable covering is sized with respect to a cleaning surface and has elastic properties that require it to stretch when placed over the cleaning surface.

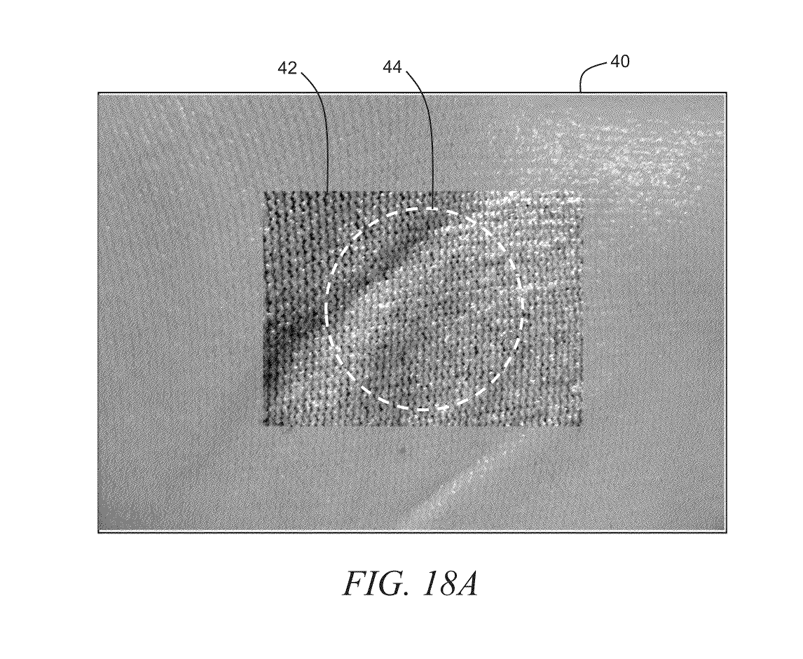

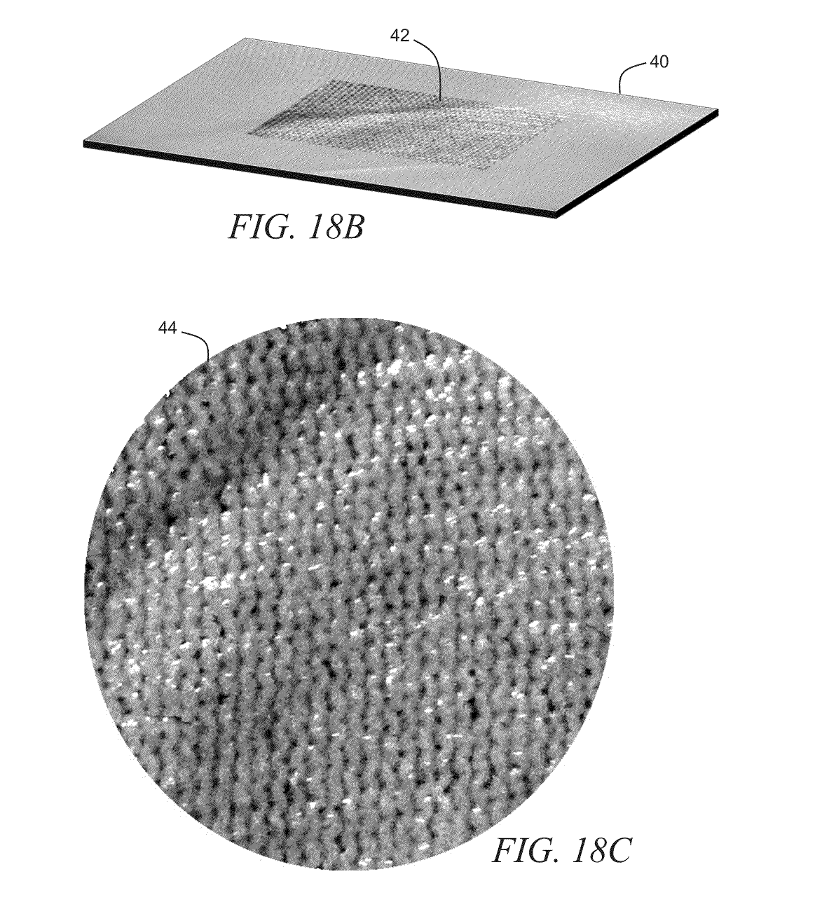

Referring to FIGS. 18A-18C, in some embodiments, a removable covering 40 is comprised of a fabric. A central portion 42 of the removable covering 40 is shown with contract enhanced to illustrate the fabric, and a portion 44 of the central portion 42 is shown enlarged in FIG. 18C. In some embodiments, the fabric is a fiber such as nylon, spandex (elastane) and/or bamboo. In some embodiments, the removable covering 40 includes a coating described herein bound to the fabric or other material making up the removable covering. In some embodiments, the coating comprises a partially cured nitrile. In some embodiments, the coating has a thickness of between approximately 50 microns and approximately 250 microns. In some embodiments, the a surface of the removable covering 40 varies by approximately 100 to approximately 200 microns. In some embodiments, a total thickness of the removable covering 40 is less than five millimeters (less than two millimeters in more particular embodiments and less than 1.6 millimeters in still more particular embodiments).

The following examples are provided to illustrate some embodiments of the glove 10 of the present disclosure but should not be interpreted as any limitation thereon. Other embodiments within the scope of the claims herein will be apparent to one skilled in the art from the consideration of the specification or the apparatuses or methods disclosed herein. It is intended that the specification, together with the examples, be considered to be exemplary only, with the scope and spirit of the disclosure being indicated by the claims which follow the examples.

### Example 1

Zeon LX 550 nitrile (Zeon Corporation, Tokyo, Japan), a partially carboxylated nitrile (approximately 7%) was mixed with a curing package that included 0.06%, 0.1% sulfur zinc oxide, and 0.1% titanium dioxide to form a coating composition. The coating composition was thinned with a solvent.

Nylon and spandex-mixed gloves were placed on Teflon-coated hand molds and then dipped into a coagulant that included 35% calcium nitrate and the coating composition so that the coating composition covered the palm portion of the gloves. The gloves were then dipped into a water wash to partially cure the gloves and cool the nitrile. The gloves were then heated/dried and cured 50-60% of the nitrile manufacture's recommended condition for complete curing. (The manufacturer recommended 120° C. for 20 minutes for complete curing). The gloves were not washed after the drying process and were found to be efficacious in removing pet hair, creating an electrostatic charge and tackiness.

### Example 2

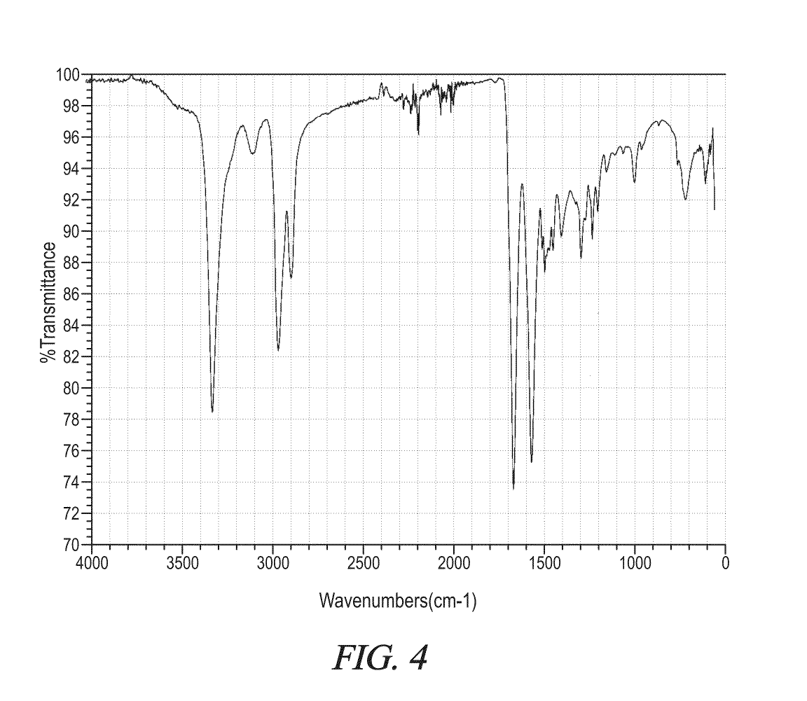

FIGS. 4-15 and Table 1, as described below, provide additional information concerning the composition of an illustrative glove 10 of another embodiment of the present invention. It will be understood that the chemical composition below is merely exemplary and the glove 10 may contain 0, 1 or several of the components described below.

FT-IR (Fourier Transform Infrared Spectroscopy)/ATR

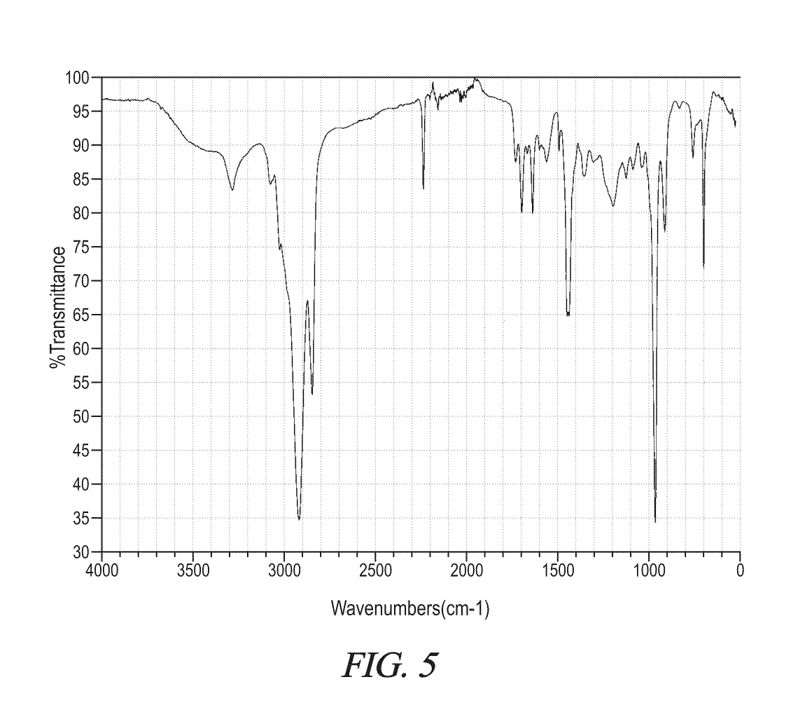

FIG. 4 provides a FT-IR/ATR 4000-550 cm⁻¹ spectrum of the back hand portion 16 of a coated glove 10 of one embodiment of the present invention. FIG. 5 provides a FT-IR/ATR 4000-550 cm⁻¹ spectrum of the palm portion 14 of the exemplary coated glove 10. The experimental conditions of the FT-IR/ATR were as follows: Both sides were analyzed using a DURASCOPE diamond attenuated total reflectance (ATR) accessory on a Thermo-Nicolet Nexus 670 FT-IR spectrometer running OMNIC software with VALPRO Qualification software (version 8.0.342 from Thermo Scientific 1992-2008). The spectra were recorded, software corrected for the ATR accessory and baseline shift and peak picked. The main absorbance bands in the FT-IR spectrum of the back portion 16 were characteristic of a polyamide and the main absorbance bands in the FT-IR spectrum of the palm portion 14 were characteristic of poly (butadiene-co-acrylonitrile).

GC-MS

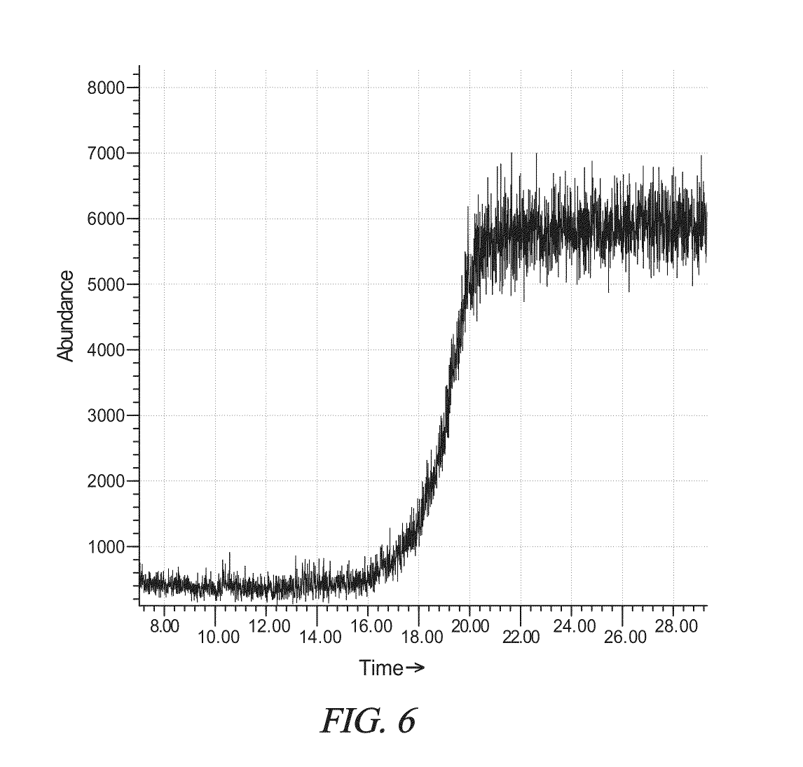

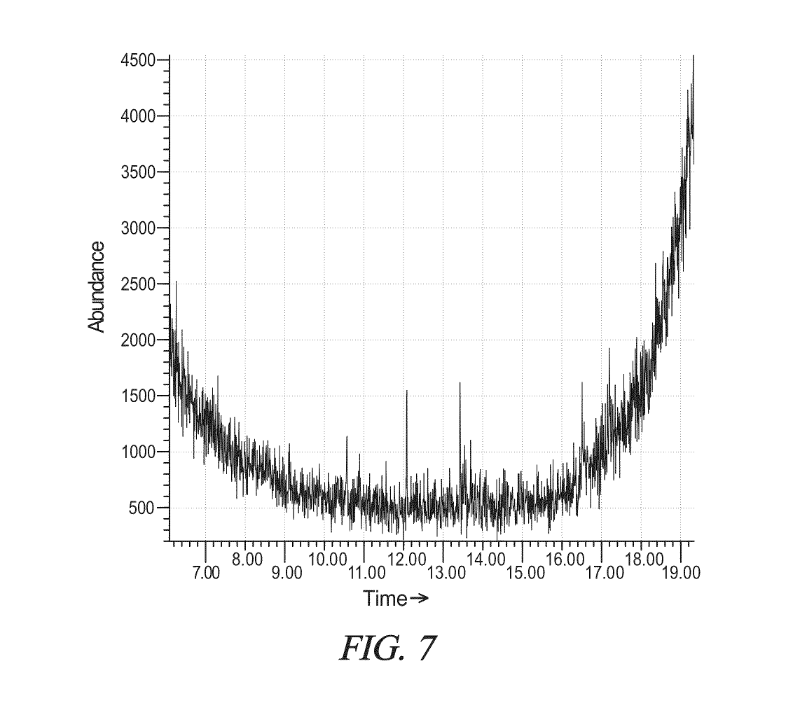

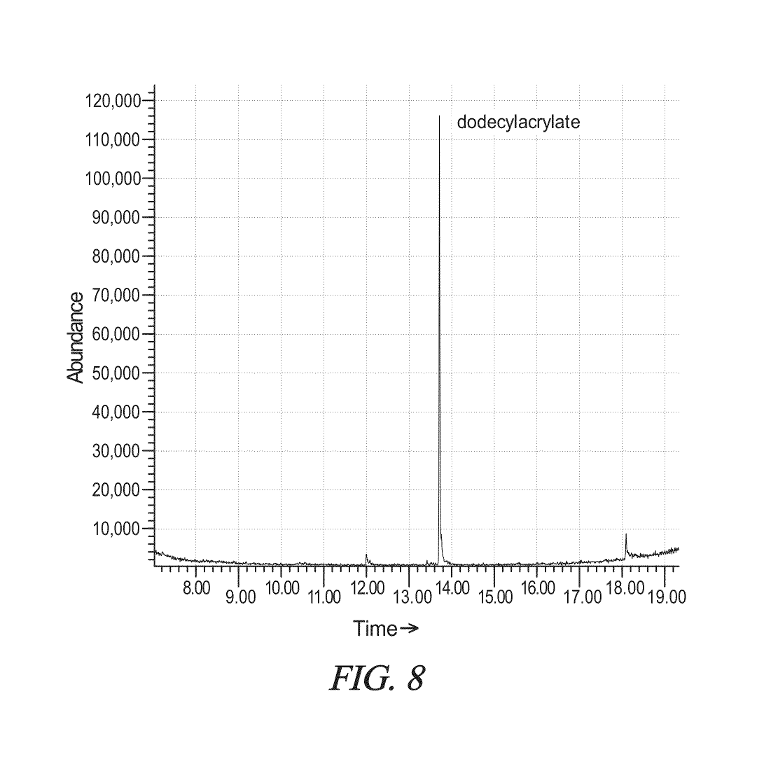

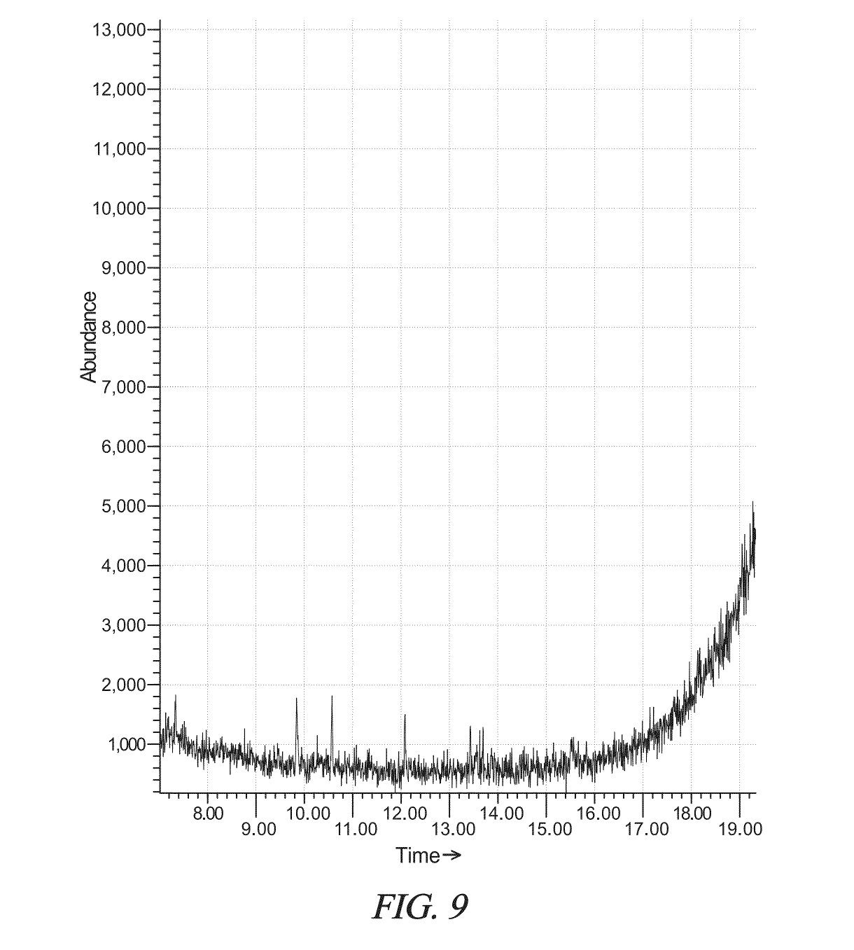

FIG. 6 is a gas chromatography-mass spectrometry (GC-MS) of the glove 10 extracted with chloroform, FIG. 7 is a gas chromatography-mass spectrometry (GC-MS) of the glove 10 extracted with benzene, FIG. 8 is a gas chromatography-mass spectrometry (GC-MS) of the glove 10 extracted with N,N-dimethylformamide (DMF) and FIG. 9 is a gas chromatography-mass spectrometry (GC-MS) of the glove 10 extracted with tetrahydrofuran. In particular, about 1 gram portions of the glove 10 were extracted with chloroform, tetrahydrofuran (THF), benzene, and N,N-dimethylformamide (DMF) for approximately two hours. The extracts were centrifuged and the supernatants were injected and analyzed by GC-MS. Gas chromatography analysis was performed under the following chromatographic conditions:

Capillary Column: ZB-5MS, 30 m×0.25 mm I.D.×0.25 μm film thickness; Inlet Temperature: 300° C.

Carrier Gas (He) Flow: Constant Flow at 1 mL/min

Injection Volume: 1 μL split injection, 10:1 split ratio

Temperature Program: 40° C. (2 min) increased at 15° C./min to 300° C. (10 min)

Transfer Line: 300° C.

Detector: Agilent 5973 MSD, Scan m/z 30-400

The sample was extracted with four different solvents to determine if any polymer additives were present. GC-MS analysis of the nitrile extracts of benzene, tetrahydrofuran, and chloroform did not detect any polymer additives. The extract from N,N-dimethylformamide detected dodecyl acrylate. The total ion chromatograms for the four extracts are included as FIGS. 6-9.

LC-MS

A portion of the chloroform extract that was prepared for the GC-MS analysis was also utilized for the LC-MS (liquid chromatography-mass spectrometry) analysis. Three milliliters of the chloroform extract was diluted with six milliliters of acetonitrile for this analysis. The resulting extract was filtered through a combination of two 25 mm filters: a Whatman 2.7 μm GF/D with GMF filter and a PALL 0.45 μm PVDF Acrodisc LC filter. Both the chloroform extract and a procedural blank were treated with the above procedure.

The sample extract was injected into an Agilent 1100 Series HPLC system equipped with a multiple wavelength detector (UV detector) and a LC-MSD Trap mass spectrometer (ion trap). The UV absorption was monitored at a wavelength of 210 nm. The separation was also monitored by mass spectrometry to provide peak assignments. The mass spectrometer utilized both positive and negative atmospheric pressure chemical ionization (APCI) as the ionization source for sample injections. Experiments were conducted using MSn to obtain fragmentation data on the sample analytes, and separations were achieved using a 30 mm×4.6 mm Cadenza CD-C18 column with 3 μm particles.

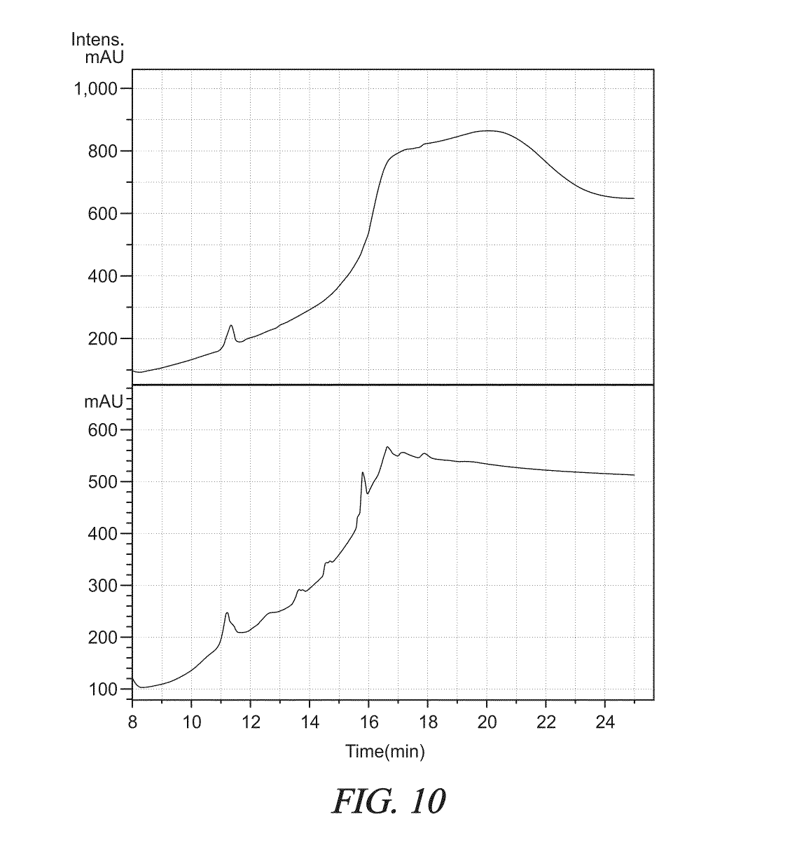

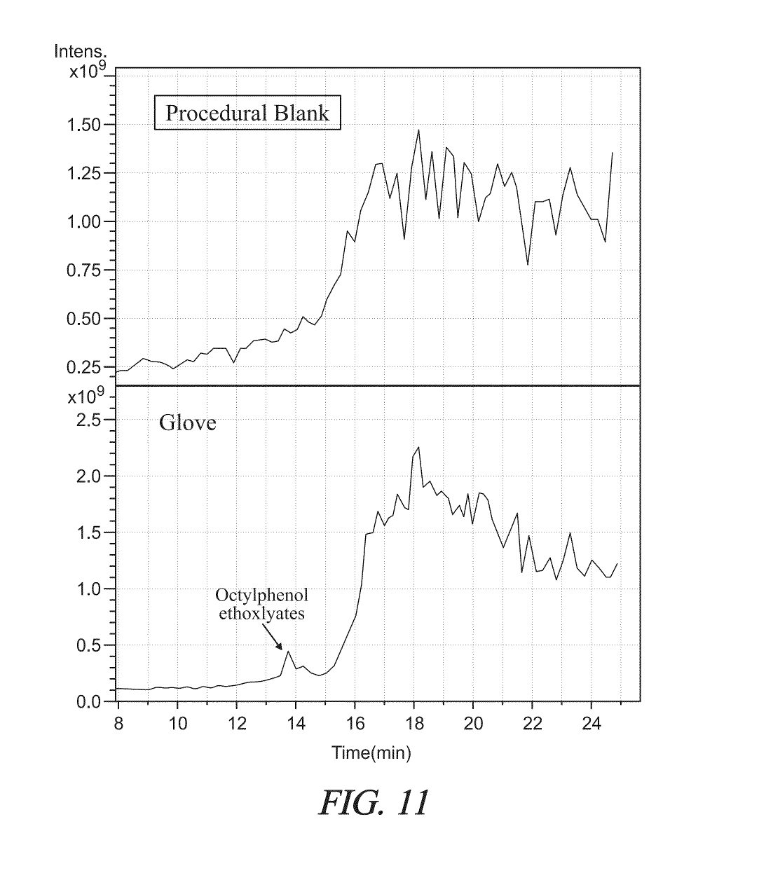

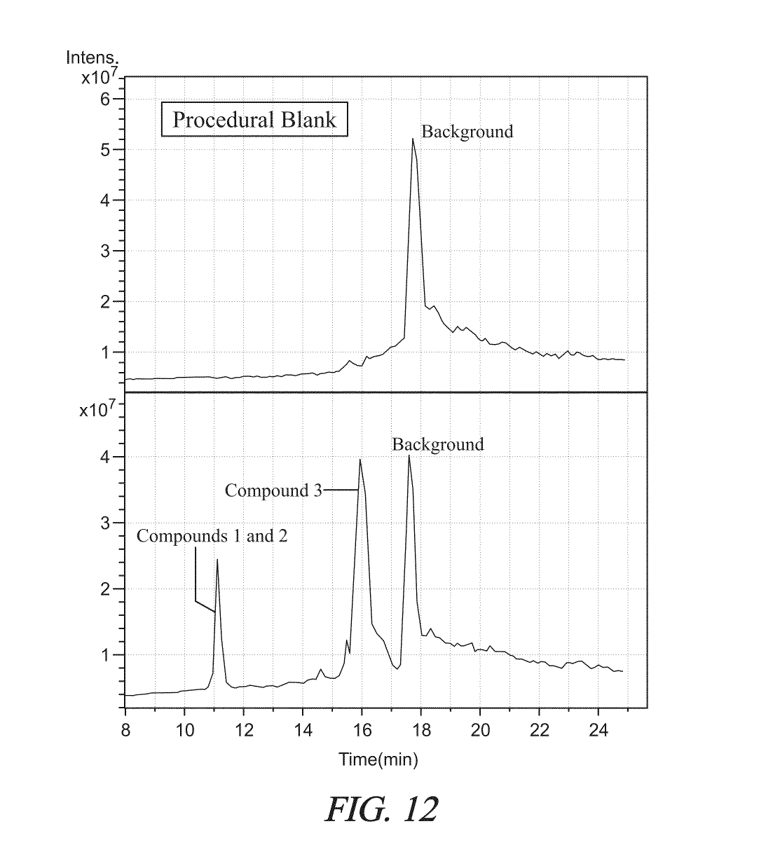

The HPLC-UV plots and the total ion chromatograms that were obtained for the sample extract using LC-MS are shown in FIGS. 10-12. Several small signals were detected by HPLC-UV as illustrated in FIG. 10. (FIG. 10 is a HPLC chromatogram at 210 nm of the glove 10 and a procedural blank. The chromatographic region from 8 to 26 minutes is provided in these plots to show more detail for the analysis). One of the signals at a retention time of 13.7 minutes correlates with the octylphenol ethoxylates that were detected by LC-MS in the positive APCI mode (see FIG. 11). (FIG. 11 is a total ion chromatogram of the glove 10 and a procedural blank using the positive APCI mode. The chromatographic region from 8 to 26 minutes is provided in these plots to show more detail for the analysis). Two signals were detected by HPLC-UV at retention times of 11.1 and 15.9 minutes in the sample extract that correlated with components that were detected by LC-MS in the negative APCI mode (FIG. 12). (FIG. 12 is a total ion chromatogram of the glove 10 and a procedural blank using the negative APCI mode. The chromographic region from 8 to 26 minutes is provided in these plots to show more detail for analysis). The signal at 11.1 minutes also appears to have a background contribution from the procedure as this signal was also observed in the procedural blank. As noted above, a small amount of octylphenol ethoxylates (approximately nine ethoxylated units on average) was observed at retention time of 13.7 minutes by LC-MS using the positive APCI mode as illustrated in FIG. 11 (ions were observed at mass-to-charge ratios of 559.8, 603.6, and 647.5). Some polyethylene glycol was also observed in the sample at earlier retention times. The polyethylene glycol could be originating from the octylphenol ethoxylates or could be added as a separate component. No other components were detected at significant amounts in the sample extracts via this mode of analysis. At least three components were detected by LC-MS using the negative APCI mode as illustrated in FIG. 12. These compounds also appear to be detected by ITV at 210 nm, but not at 254 nm. No corresponding positive ion spectra or GC-MS data were generated for these three components to assist with spectral interpretation. The lack of a response at 254 nm with UV detection indicates that these compounds do not contain aromatic or conjugated unsaturation. The lack of positive ion mass spectral response for these species indicates that the compounds most likely contain acidic functionality, carboxylic acid, phosphate, sulfate, or amide (the nitrogen is acidic in an amide and not basic as the nitrogen in an amine). The most abundant ions in these mass spectra are most likely deprotonated ions (M-H) and not odd electron radical ions (M)− (radical anions are possible for nitroaromatic species, but the lack of UV response at 254 nm indicates that these species are not present in the sample). Based on this premise, no MW matches were found from an internal list of additives except for three possible matches with various Tinuvin stabilizers for three of the quasimolecular ions observed in the original spectrum at 11.4 to 11.5 minutes. These ions could be some type of amide slip agent, hindered-amine light stabilizer (HALS), or possibly a phosphite stabilizer. Mass spectral data that are obtained in the positive APCI mode are typically one mass unit higher than the molecular weight of a compound, and mass spectral data that are obtained in the negative APCI are typically one mass unit less than the molecular weight of a compound.

Detailed Examination of Mass Spectral Data for Compounds 1 through 3

Spectra at 11.1 Minutes (Spectra #215 and #216)—Detailed Interpretation for Compound 1.

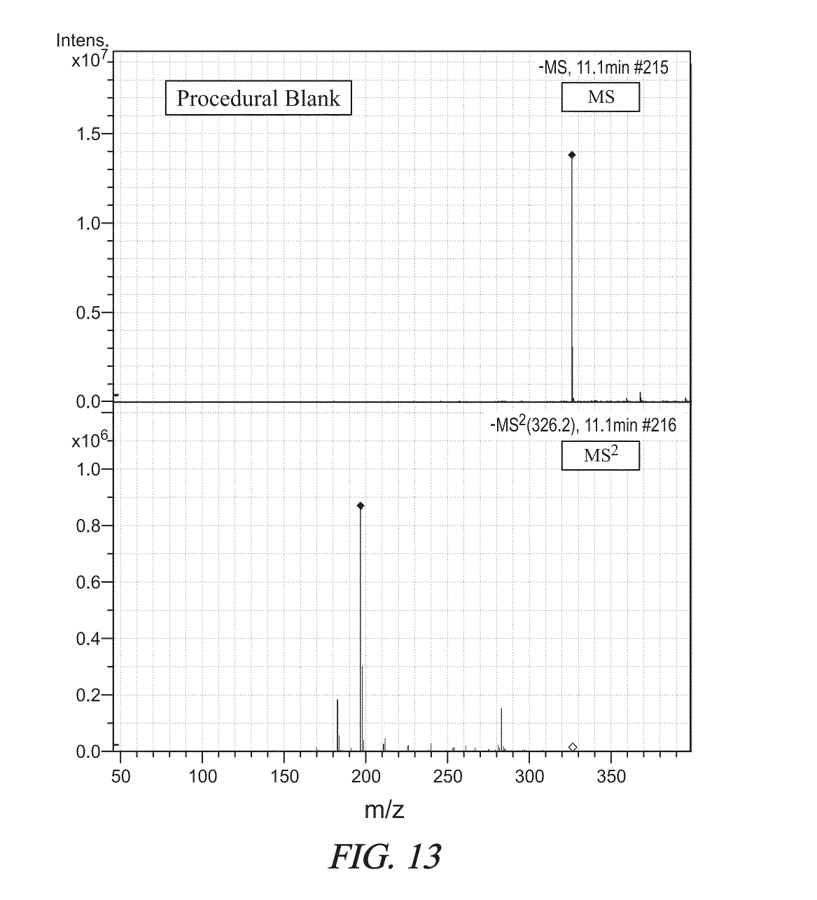

The base peak in the mass spectrum is the ion at m/z 326.2 which is proposed to be a deprotonated ion and indicates that the MW for this species is 327 (FIG. 13). (FIG. 13 is the mass spectra for Compound 1). This would indicate that the species contains nitrogen. The base peak in the MS² spectrum is the ion at m/z 196.7 which is the loss of 129.5 from the parent ion. This could possibly represent a loss of an octylamine group from the deprotonated ion. The second most abundant ion is the fragment ion at m/z 283.0 which is a loss of 43 from the deprotonated ion. This likely represents a 3 carbon alkyl fragment. The lack of a UV response at 254 nm indicates that aromatic functionality is unlikely. This information along with the proposed MW of 327, indicate this species is most likely not 2-hydroxy-4(octyloxy)benzophenone (MW326). [Also, 2-hydroxy-4-(octyloxy)benzophenone should be detected by GC/MS]. A definitive identification was not possible.

Spectra at 11.4-11.5 Minutes (Spectra #221-#223)—Detailed Interpretation for Compound 2

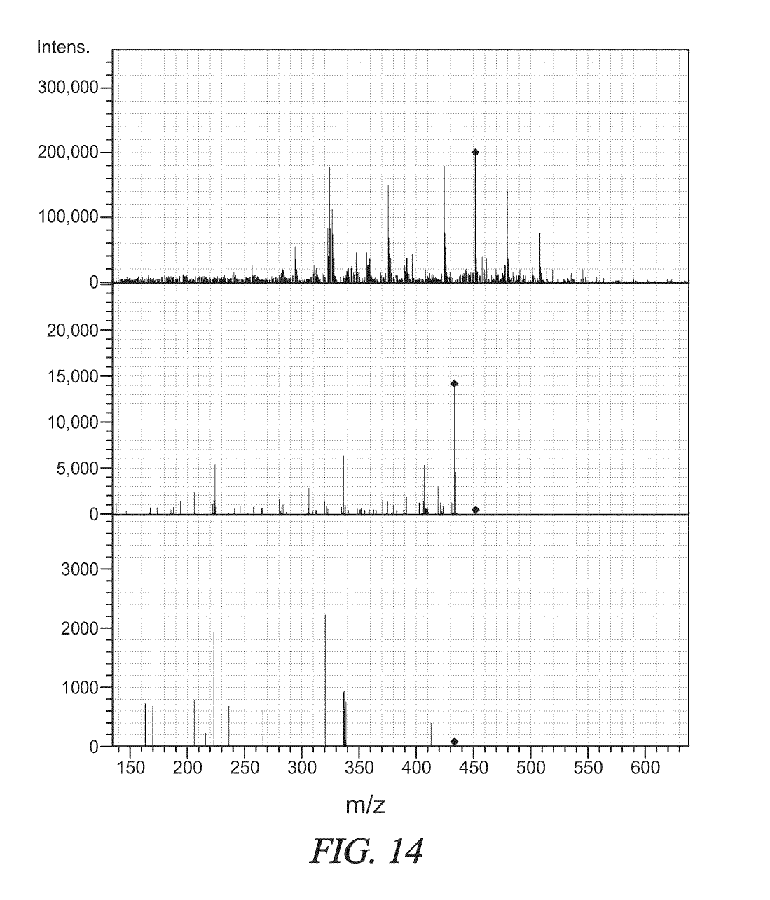

The mass spectral data is about two orders of magnitude less intense for Compound 2, as compared to Compounds 1 and 3 (see FIG. 14). (FIG. 14 is the mass spectra for Compound 2). The base peak in the mass spectrum is the ion at m/z 451.6 which may indicate a MW of 453. If so, the compound would contain nitrogen. No match was found of this MW from an internal list of polymer additives. Other significant ions are observed at 325.0, 375.7, 424.5, 479.5 and 507.5. The 325 ion may represent the deprotonated ion for MW 326 and could indicate the presence of a low level of 2-hydroxy-4-(octyloxy)benzophenone. The 424.5 ion may represent the deprotonated ion for MW 425, and could represent the presence of Tinuvin 1577. The 479.5 ion may represent the deprotonated ion for MW 480, and could represent the presence of Tinuvin 770. The 507.5 ion may represent the deprotonated ion for MW 508, and could represent the presence of Tinuvin 292. The base peak in the MS spectrum (451.8 parent ion) is the 433.3 ion. This ion may indicate the loss of water from the parent ion and may represent the presence of carbonyl, carboxyl, or hydroxy functionality. The signal intensity for the MS³ ion is very weak. The base peak in the MS spectrum for the 451.8 ion is the fragment ion at 320.9 and represents the loss of 112 from the 433.3 ion which could represent the loss of an octyl group. A definitive identification was not possible.

Spectra at 15.9 Minutes (Spectra #308-#310)—Detailed Interpretation for Compound 3

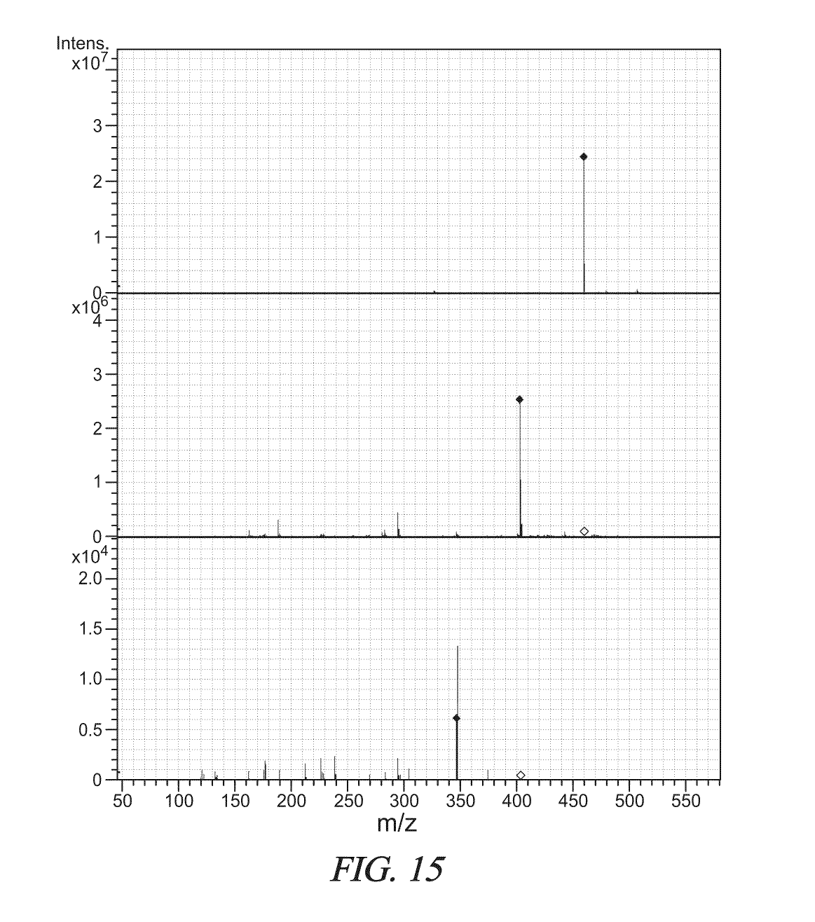

The base peak in the mass spectrum is the ion at m/z 460.1 which is proposed to be a deprotonated ion and indicates that the MW for this species is 461 (FIG. 15). (FIG. 15 is a mass spectra for Compound 3). This would indicate that the species contains nitrogen. The base peak in the MS² spectrum is the ion at m/z 403.2 which is the loss of 57 from the parent ion. This could possibly represent a loss of a t-butyl group from the deprotonated ion. A second fragment ion is seen at m/z 295.1 and could indicate the subsequent loss of an octyl group from the 403.2 ion. The base peak in the MS 3 spectrum is the fragment ion at m/z 348.0 with a second large fragment ion at m/z 347.1. The 348.0 fragment ion is a subsequent loss of 55 from the 403 ion and may represent a C₄H₇ which may indicate the presence of a second t-butyl group. A definitive identification was not possible.

ICP-OES

The inorganic components of the glove 10 were investigated by inductively coupled plasma-optical emission spectroscopy (ICP-OES). Approximately 200 mg of the sample were subjected to microwave digestion using 5 mL of concentrated nitric acid (HNO 68%), and 5 mL of de-ionized (DI) water. After digestion the sample solution was clear and colorless, without any solid residues, and it was further diluted to 50 mL with DI water for the analysis. The following conditions were used for the microwave digestion:

Max power: 1600 W

Ramp time: 35 min

Temperature: 200° C.

Holding time: 30 min

A Thermo Scientific iCAP 6300 Duo spectrometer was used under the following conditions:

RF Power: 1150 W

Peristaltic Pump Rate: 25 rpm

Auxiliary Gas Flow Rate: 0.50 L/min

Nebulizer Gas Flow Rate: 0.70 L/min

Purge Gas: Argon

Multi-element calibration standards were prepared at 0.1, 1, and 5 ppm. Calibration curves were found to be linear with an R² value of 0.99 or better.

The results, adjusted for sample weight and dilution, are presented in Table 1 below. The most abundant elements found were calcium, potassium and sulfur (>1000 ppm).

TABLE 1

| Element | Symbol | ppm (μg/g) | Detection Limits |
|---|---|---|---|
| Silver | Ag | N/D | 0.2 |
| Aluminum | Al | 15.5 | 0.1 |
| Arsenic | As | N/D | 0.3 |
| Boron | B | N/D | 0.3 |
| Barium | Ba | <0.2 | 0.1 |
| Beryllium | Be | N/D | 0.1 |
| Calcium | Ca | 2196.3 | 0.3 |
| Cadmium | Cd | N/D | 0.1 |
| Cerium | Ce | N/D | 0.9 |
| Cobalt | Co | N/D | 0.7 |
| Chromium | Cr | N/D | 0.3 |
| Copper | Cu | <0.5 | 0.2 |
| Iron | Fe | 9.3 | 0.1 |
| Germanium | Ge | N/D | 1.1 |
| Potassium | K | 1023.6 | 0.1 |
| Lithium | Li | N/D | 0.1 |
| Magnesium | Mg | 39.8 | 0.1 |
| Manganese | Mn | 1.7 | 0.1 |
| Molybdenum | Mo | N/D | 0.2 |
| Sodium | Na | 647.6 | 0.3 |
| Nickel | Ni | 2.1 | 0.1 |
| Phosphorous | P | 517.5 | 0.2 |
| Lead | Pb | N/D | 0.1 |
| Sulfur | S | 1996.2 | 2.4 |
| Antimony | Sb | <1.8 | 0.5 |
| Selenium | Se | N/D | 0.5 |
| Silicon | Si | 40.5 | 0.7 |
| Tin | Sn | N/D | 0.4 |
| Strontium | Sr | 1.7 | 0.1 |
| Titanium | Ti | 190.1 | 0.3 |
| Thallium | Tl | N/D | 0.6 |
| Vanadium | V | N/D | 0.1 |
| Zinc | Zn | 6.6 | 0.1 |
| Zirconium | Zr | <0.2 | 0.1 |

N/D = Not detected

While the invention has been primarily shown and described in conjunction with the removal of pet hair from a plethora of surfaces, it is understood that a wearable hand covering described herein can be utilized in removing any type of loose debris present on a surface.

Having now described the invention in accordance with the requirements of the patent statutes, those skilled in the art will understand how to make changes and modifications to the disclosed embodiments to meet their specific requirements or conditions. Changes and modifications may be made without departing from the scope and spirit of the invention, as defined and limited solely by the following claims.

What is claimed is:

1. A method of removing pet hair from a surface, the method comprising:
moving a material including a fabric and a dried coating bound to the fabric along the surface, wherein the dried coating includes partially cured nitrile, and wherein the material is configured to adhere to pet hair via electrostatic charging attraction between the coating and the pet hair; and
removing the pet hair from the material.

2. The method of claim 1, wherein the removing includes washing the material to remove the pet hair.

3. The method of claim 1, wherein the material consists essentially of a single layer of the fabric and the dried coating.

4. The method of claim 1, wherein the material is elastic.

5. The method of claim 1, wherein the fabric is a fiber selected from the group consisting of nylon, elastane, bamboo and combinations thereof.

6. The method of claim 1, wherein the material forms a removable covering for a cleaning instrument, the method further comprising covering a surface of the cleaning instrument with the removable covering prior to the moving, wherein the moving includes using the cleaning instrument to place the removable covering in contact with the surface.

7. The method of claim 6, wherein the removable covering includes an elastic opening for selectively covering and uncovering the surface of the cleaning instrument.

8. The method of claim 1, wherein the material forms a glove, the method further comprising placing the glove on a hand of a user, wherein the moving includes using the hand of the user to place the glove in contact with the surface.

9. The method of claim 8, wherein the glove includes a plurality of fingers extending from each of a plurality of finger openings.

10. The method of claim 1, wherein the dried coating further includes a coagulant including calcium nitrate.

11. The method of claim 1, wherein the dried coating is adhered to the fabric via an adhesive.

12. The method of claim 1, wherein the partially cured nitrile is partially carboxylated nitrile.

13. The method of claim 1, wherein the material has a total thickness less than approximately five millimeters.

14. The method of claim 13, wherein a surface of the material varies by approximately 100 to approximately 200 microns.

15. The method of claim 13, wherein the dried coating has a thickness of between approximately 50 microns and approximately 250 microns.

16. The method of claim 1, wherein the surface is a fabric.

17. A method of removing pet hair from a fabric surface, the method comprising:
placing a glove on a hand of a user; and
moving the glove along the fabric surface, wherein the glove is formed of a material including a fabric and a dried coating bound to at least a portion of the fabric, wherein the dried coating includes partially cured nitrile, and wherein the glove is configured to adhere to pet hair via electrostatic charging attraction between the coating and the pet hair.

18. The method of claim 17, wherein the material is elastic and consists essentially of a single layer of the fabric and the dried coating.

19. A method of removing pet hair from a fabric surface, the method comprising:
covering a surface of a cleaning instrument with a removable covering; and
moving the removable covering along the fabric surface using the cleaning instrument, wherein the removable covering is formed of a material including a fabric and a dried coating bound to at least a portion of the fabric, wherein the dried coating includes partially cured nitrile, and wherein the removable covering is configured to adhere to pet hair via electrostatic charging attraction between the coating and the pet hair.

20. The method of claim 19, wherein the material is elastic and consists essentially of a single layer of the fabric and the dried coating.
